(19) United States
(12) Patent Application Publication
(10) Pub. No.: US 2014/0332477 A1
(43) Pub. Date: Nov. 13, 2014

(54) Apparatus to Dispense Immiscible Liquid from an Inverted Bottle

(71) Applicant: John R. Troost, Akron, OH (US)

(72) Inventor: John R. Troost, Akron, OH (US)

(21) Appl. No.: 14/341,975

(22) Filed: Jul. 28, 2014

Related U.S. Application Data
(63) Continuation-in-part of application No. 13/847,451, filed on Mar. 19, 2013.

(51) Int. Cl. C02F 1/00

(52) U.S. Cl. CPC C02F 1/00; C02F 2101/30
USPC 210/799; 210/248

(57) ABSTRACT

A device, an improvement upon a funnel, to enable immiscible liquids to be dispensed from an inverted bottle to augment a new, in-situ method to extract chemicals from water directly within sampling containers.

### CROSS-REFERENCE

This application is a continuation-in-part of Utility patent application Ser. No. 13/847,451 filed Mar. 19, 2013.

### BACKGROUND

This invention relates in general to a method and apparatus for extracting organic chemicals from water directly within sample collection vessels. More specifically, the invention relates to an apparatus and procedure designed to effect the removal of an immiscible solvent from an inverted bottle following an in-situ liquid-liquid extraction process.

Water is routinely sampled and tested for chemical contaminants for human health and a number of other reasons. Most chemical analysis methods require removal of organic chemicals from water by partitioning into an immiscible solvent, often heavier than water, by a process known as liquid-liquid extraction. If the pollutants to be extracted have a greater affinity for the solvent than the water, and, if there is sufficient interaction between the extracting solvent and the water, the contaminating chemicals transport from the water to the solvent and the process will be effective. There are two techniques commonly in use today.

The most common features of a separatory funnel—generally a pear shaped vessel fashioned with a cap at a large end and a stop-cock at a narrow end. A water sample and an appropriate, substantially immiscible, organic extracting solvent are added together within the separatory funnel and it is vigorously shaken either manually or mechanically to facilitate the interaction between the water and solvent. Subsequently, the separatory funnel is stood upright and the liquid layers are allowed to settle and separate until a clear demarcation between the liquid layers may be observed. Removing the cap for ventilation and by manipulating the stopcock, the lower layer (heavier than water solvent now containing the water pollutants) is manually drained off into another container by observing the movement of the visible interface (meniscus) between the two fluids. The housing of the separatory funnel, or at least a portion of it, must necessarily be clear or at least translucent to facilitate viewing a moving interface. It is often important for quantitative work to Obtain a complete separation between the water and solvent layers. The procedure is often repeated with fresh solvent to maximize the effectiveness of the process. Thus, a separatory funnel has a dual purpose, to provide a mixing chamber for water and an extracting solvent while also serving as a vehicle for separating two liquids following the extraction. An example of a separatory funnel and an associated patent may be found in U.S. Pat. No. 1,049,411 issued to Roscoe H. Shaw on Jan. 7, 1913.

U.S. Pat. No. 5,478,478 issued to Sandra Griswold on Dec. 26, 1995 introduced a modification to facilitate the separation of two fluids within a separatory funnel by preventing vortexing. U.S. Pat. No. 5,580,528 issued to James P. Demers on Dec 3, 1996 introduces an unbreakable plastic stem to a glass separatory funnel improving the safety and durability of the device.

Another technique commonly used to extract water samples is continuous liquid-liquid extraction, which makes use of an elaborate glass apparatus to automate the process. A heavier than water, immiscible solvent (typically methylene chloride) is boiled and vaporized up into a cold water jacket. Recondensed solvent falls, dropwise, into a vessel containing the water sample. The heavier than water solvent is continually recycled into a boiling flask and back up into the cold condenser. The initial process generally takes 18 to 24 hours and is most often followed by a second extraction of 18 to 24 hours after altering the pH of the water sample. U.S. Pat. No. 5,156,812 is an example of this apparatus.

With a fairly new technique, organic compounds may also be removed from water by passing the water through a solid sorbent material from which the pollutants may subsequently be dislodged with solvent or a mixture of solvents.

With these procedures the separated solvent, now containing the chemicals that had originally been in the water, is usually reduced in volume (concentrated) by evaporation to enable the extracted organic compounds to be detected at extra low levels. However, all of these processes are labor intensive, costly, time-consuming and subject to contamination from a number of sources.

This invention, the object of this patent application, was born of a need to remove extracting solvent from a bottle, an obstacle posed by the development of a new, greatly simplified method for extracting chemicals from water. With the new technique, solvent (or a mixture of solvents) is added directly to the water in original sample vessels to enable the extraction to take place directly within the bottles used to collect, transport and store the water samples (an in-situ extraction). Once the solvent(s) is introduced, the bottles are spun horizontally for a number of hours at 3 rpm. This subtle movement provides the necessary interaction between the water and solvent to obtain an extraction result equaling or exceeding the efficiency of those processes described above. This new method for extracting chemicals from water, of which this patent application device is an essential element, has important advantages. Among these are significant solvent usage reduction (a green technology), labor abatement, improved precision, contamination minimization, enhanced safety, and greatly reduced cost.

The initial research conducted to explore and refine the new extraction method was necessarily, counterproductively, administered using a piece of equipment the technique was, in part, designed to replace. A separatory funnel (as mentioned above) was the only tool available to effect the removal of the extracting fluid from the bottles following the in-situ process. A clear and obvious need to find a simpler means to dispense the extracting solvent from an inverted bottle led to the discovery and refinement of the subject device (given the name “funnel-cock”).

The device is a modification of a funnel. There is prior art regarding the improvement of funnels. In 1866, two patents were issued, one to Arthur Wilson (U.S. Pat. No. 53,074) to allow a funnel to be attached to a faucet to control flow. The second patent was issued to A. H. Whitney (U.S. Pat. No. 55,941) entailing an improvement to a funnel to allow liquids to be measured and dispensed in a simplified manner. U.S. Pat. No. 105,857, issued to Franklyn Smith Jul. 26, 1870, describes an improvement to a measuring funnel to enable flammable liquids to be dispensed safely by eliminating exposure to air.

The present invention is a funnel adaptation device created to enable immiscible solvent to be dispensed from an inverted bottle in a controlled, efficient manner, and with enhanced safety at a greatly reduced cost.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a funnel adaptation created to enable immiscible solvent to be dispensed from an inverted bottle in a controlled, efficient manner. The device is fabricated of a clear or translucent material, etched with grooves or forged with ridges on the inner surface and fitted with a stopcock. The large opening of the funnel is sized specifically to comfortably seat and mate with the lip of inverted bottles of varying sizes and shapes, particularly those commonly used for water sampling (typically glass, quart-sized, round, narrow neck vessels). The dimensions are further refined to create a gap to retain the inevitable but limited spillage that occurs when a bottle full of liquid(s), is inverted onto the device.

The grooves or ridges are strategically placed to prevent a seal from forming between the inverted bottle lid and the inner funnel surface. Consequently, when the funnel is used to discharge a heavier than water solvent from an inverted bottle, the grooves or ridges allow air to enter the bottle while the fluid is being dispensed thereby striking a balance between a vacuum formed within the bottle headspace and atmospheric pressure. The clear or translucent construction material allows the fluid discharge to be viewed while the flow is controlled with a stopcock.

More specifically, the invention entails a funnel of specific conical size and shape made of clear or translucent material, or containing at least a section of clear or translucent material, with a larger circular open top end and a smaller tubular lower end. The smaller tubular end may house or be fashioned to house a stopcock or other flow controlling mechanism. The inner surface of the upper part of the funnel is etched with one or more grooves or is fabricated with one or more ridges. As the bottle full of liquid and funnel are clasped and inverted together, the purposeful extension of the funnel beyond the lid of the bottle is made to create a void sufficient to retain overflow limited and controlled by the natural competing forces of vacuum and atmospheric pressure.

Moreover, the sizing allows for a snug fit (but not seal) about the neck of the bottle while the funnel wall is extended up over the neck up to but not quite reaching the base of the bottle. Thus an overflow containment space is formed within the flat funnel wall, the cylindrical bottle neck and the lip of the bottle. The groove(s) or ridges(s) within the funnel prevent a seal about the lid of the bottle and allow venting to occur in a controlled fashion as the stopcock is opened and the fluid is discharged.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the funnel cock device depicting the general funnel shape, stopcock attachment and inner grooves in accordance with the disclosed architecture.

FIG. 2 illustrates a perspective view of the funnel cock device fitted to a narrow mouth bottle containing two liquid phases inverted onto a funnel cock illustrating the utility of the device in accordance with the disclosed architecture.

FIG. 3 illustrates a perspective view of another embodiment of the funnel cock device fitted to a wider mouth bottle containing immiscible liquids overturned on a funnel cock further depicting the function of the device in accordance with the disclosed architecture.

FIG. 4 illustrates a perspective view of the additional embodiment of the funnel cock device fitted to a narrow mouth bottle containing immiscible liquids overturned on a funnel cock further depicting the function of the device in accordance with the disclosed architecture.

FIG. 5 illustrates a perspective view of the additional embodiment of the funnel cock device depicting the general funnel shape, stopcock attachment and inner cross-hatching in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

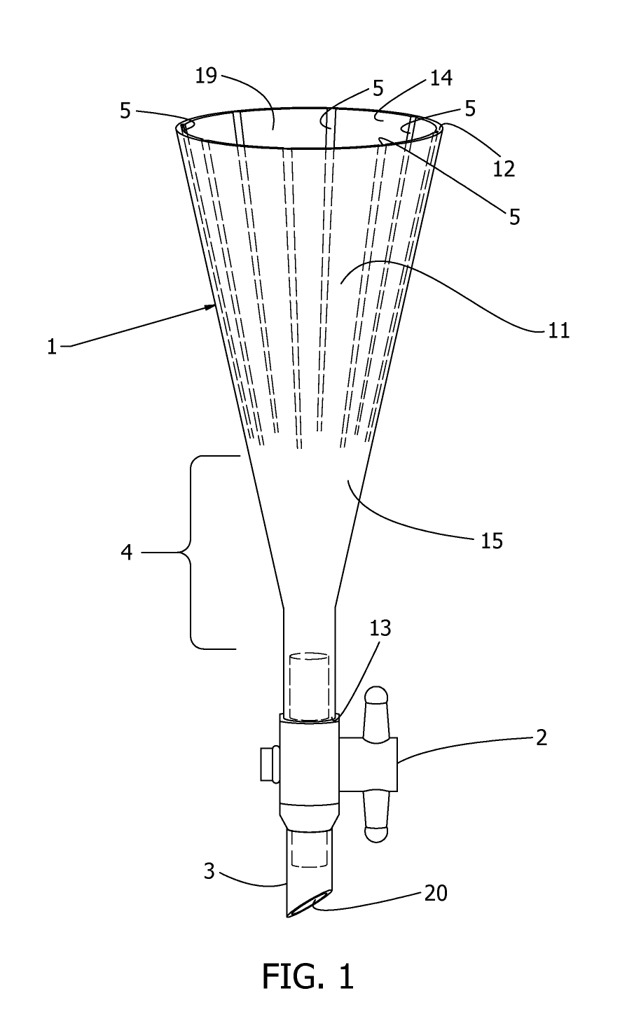

As shown in FIG. 1, the funnel cock device 1 is a funnel adaptation created to facilitate the separation of an immiscible liquid dispensed from an inverted bottle in a controlled, efficient manner. The funnel cock device 1 comprises a housing (or conical-shaped body) 11 with a smaller outlet opening 20 and a larger inlet opening 19, a stopcock 2, a spout 3 and grooves or ridges 5. To promote the intended purpose of the funnel cock device 1, the body 11 is molded of a translucent material, such as fluorinated ethylene propylene, polyethylene, polypropylene, glass, or other clear or translucent material to enable viewing 4 an interface between liquid layers passing through the device 1, though any other suitable material may be used to manufacture the funnel cock device 1 as is known in the art without affecting the overall concept of the invention.

In contrast, instead of the entire device 1, the device can comprise a section of clear or translucent material in the wall of the funnel cock device 1 between the smaller outlet opening 20 and the larger inlet opening 19 whereby an interface 18 between two immiscible liquids may be visualized as the fluids flow through the body 11 of the funnel cock device 1. Further, all construction materials including the stopcock 2 (which is typically polypropylene) are necessarily inert to prevent damage from chemically aggressive solvents often used to extract organic chemicals from water.

The funnel cock device 1 can be almost any shape or size depending on user and manufacturing preference. The body 11 comprises a top end 12, a bottom end 13, an interior surface 14, and an exterior surface 15. Typically, the funnel cock device 1 is shaped in a conical shape, but can be any suitable shape as is known in the art, as long as the funnel cock device 1 is tapered at an end to dispense a liquid therefrom. Generally, the funnel cock device 1 is tapered at the top 12 and the bottom end 13, and the top 12 is enlarged in shape to accentuate the overflow function (described below). Specifically, the funnel cock device 1 is shaped as a conical chamber having a longitudinal axis a large inlet opening 19 and a smaller outlet opening 20 for allowing liquid to pass through the chamber.

The funnel cock device 1 can also comprise a variety of colors and designs to suit user and manufacturing preference. While the shape and size of the funnel cock device 1 may vary greatly depending on the wants and needs of a user, the funnel cock device 1 is approximately between 8 and 13 centimeters in height as measured from a top end 12 to a bottom end 13, and approximately between 0.1 and 2 millimeters thick as measured from an interior surface 14 to an exterior surface 15.

The funnel cock device 1 comprises a stopcock 2 and a spout 3 secured to the bottom end 13 of the funnel cock device 1, or other liquid flow controlling device as is known in the art. The stopcock 2 and spout 3 can be any suitable stopcock and spout as is known in the art, as long as they function to control the dispensing of liquid from the tapered bottom end 13 of the funnel cock device 1. The stopcock 2 and spout 3 can be secured via any suitable securing means as is known in the art to the bottom end 13 of the funnel cock device 1, such as by gluing, press fitting, threading, etc. Typically, any shape and size stopcock 2 and spout 3 can be utilized on the bottom end 13 of the funnel cock device 1, depending on the needs and wants of a user and/or manufacturing preferences.

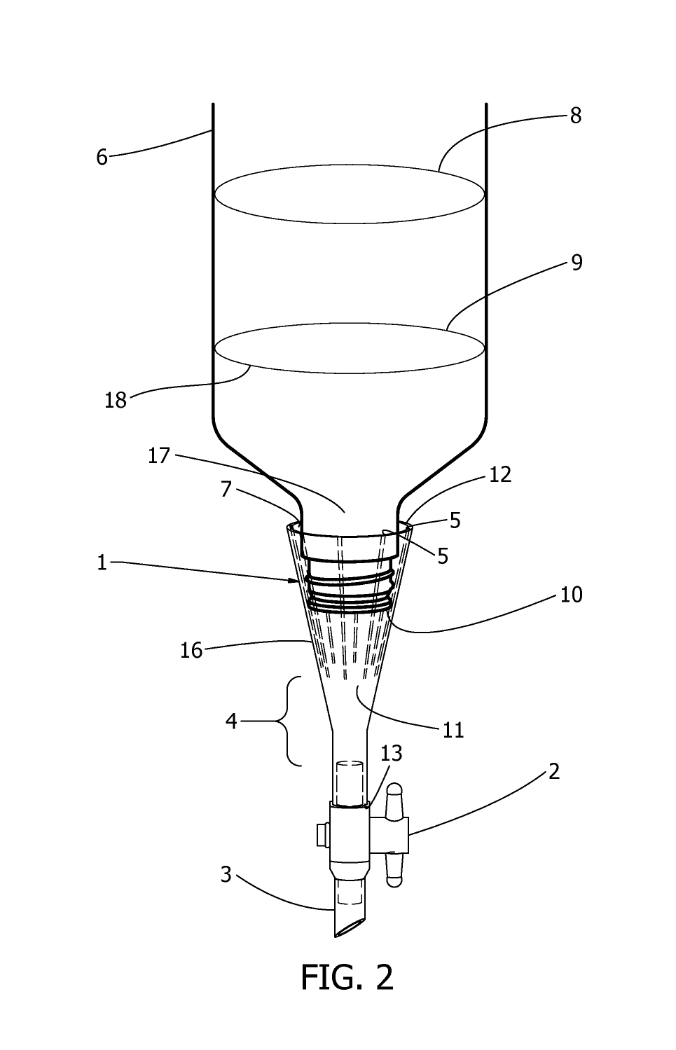

FIG. 2 illustrates the funnel cock device 1 in use. Specifically, a narrow mouth (“Boston round”) inverted bottle 6 comprising two phases of liquid, a top layer 8 and a bottom layer 9 is reposed onto an upright funnel cock device 1. However, a Boston round bottle does not have to be used and any suitable size and type of a bottle can be utilized as is known in the art, depending on the wants and needs of a user. To accomplish this, typically the funnel cock device 1 is first placed upside down on an uncapped, upright bottle 6 containing the liquid phases. The funnel cock device 1 and bottle 6 are clasped together as they are inverted. With this act of inversion, a limited amount of liquid escapes but is contained, by design, by the inner open space 7 between the interior surface 14 of the funnel cock wall 16, the lip 10 of the bottle 6 and the neck 17 of the bottle.

Specifically, the inner diameter of the large inlet opening 19 of the funnel cock device 1 is sized and shaped to exactly match the outer diameter of the lip 10 of the bottle 6 at a point typically between 1 and 6 centimeters below the top end 12, (i.e., there is a 1 centimeter or more extension of the funnel cock wall from the bottle lip 10 to the top end of the funnel cock 12). Such that when the bottle 6 is inverted and inserted onto the open large inlet 19 of the funnel cock device 1, it forms another chamber in the region between the lip 10 of the bottle 6, the neck 17 of the bottle and the interior surface 14 of the funnel cock wall 16 that is utilized to retain liquid overflow.

As the stopcock 2 is opened and the heavy liquid phase (bottom layer) 9 is permitted to traverse through the funnel cock device 1, the moving meniscus (interface) 18 between the layers is able to be viewed 4 through the translucent wall of the funnel cock device 1. The bottom liquid layer 9 may therefore be quantitatively discharged and separated from the top layer 8 by closing the stopcock 2 just as the interface 18 between the layers (8 and 9) passes into the stopcock 2.

Furthermore, the funnel cock device 1 comprises one or more substantially vertical grooves or ridges 5 on the interior surface 14 of the funnel cock wall 16 traversing the point at which the diameters of the funnel cock device 1 and the lip 10 of the mated bottle 6 are identical, and preventing a seal from forming while allowing air to enter the bottle 6 when fluids within the mated bottle 6 inverted onto the funnel cock device 1 are discharged.

In a preferred embodiment, a plurality of grooves or ridges 5 can be positioned on the interior surface 14 of the funnel cock wall 16, and are limited to the area where the inverted bottle 6 contacts the funnel cock device 1 (i.e., the point at which the diameters of the funnel cock device 1 and the lip 10 of the mated bottle 6 are identical). Further, the plurality of grooves or ridges 5 (or seal preventing protrusions/indentations) can all be identical in size or the plurality of groove or ridges 5 can each be of different sizes and orientation. The purpose of the plurality of grooves or ridges 5 is to prevent a seal between the lip of the bottle 6 and the funnel cock device 1, thus allowing air to enter the bottle 6 as the liquid is discharged. Without the plurality of grooves or ridges 5, the flow stops prematurely.

Further, if the plurality of grooves or ridges 5 are too large, the containment chamber (i.e., the chamber in the region between the lip 10 of the bottle 6, the neck 17 of the bottle and the interior surface 14 of the funnel cock wall 16 that is utilized to retain liquid overflow) will overflow as the bottle 6 is overturned onto the funnel cock device 1. Specifically, the plurality of grooves or ridges 5 must be between 0.1 to 1 millimeters in depth or height to perform the required function.

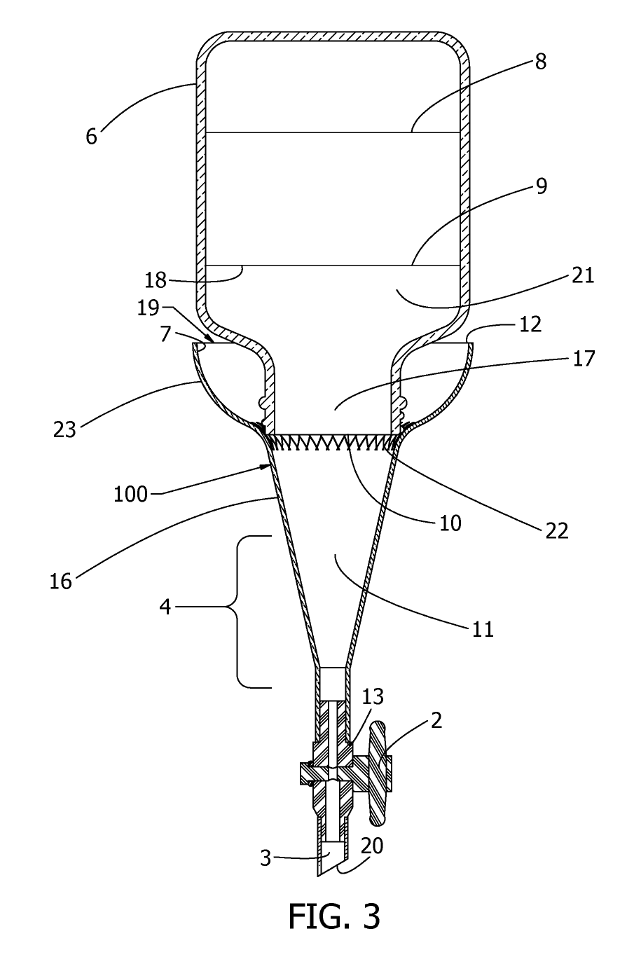

In another embodiment, instead of a plurality of grooves or ridges 5 the funnel cock device 1 comprises an etched or cross-hatched configuration of grooves or ridges 22 (as shown in FIG. 3). Additionally, the etched or cross-hatched grooves or ridges 22 could be in lieu of or in addition to the vertical grooves or ridges 5. Further, the cross-hatched grooves or ridges 22 must also be between 0.1 to 1 millimeters in depth or height to perform the required function, and are typically 0.5 to 2 centimeters in length. Typically, the cross-hatched grooves or ridges 22 are positioned on the interior surface 14 of the funnel cock wall 16, and are limited to the area where the inverted bottle 6 contacts the funnel cock device 1 (i.e., the point at which the diameters of the funnel cock device 1 and the lip 10 of the mated bottle 6 are identical). Furthermore, the funnel cock device 1 will not function properly if any of the above-described elements are absent.

FIG. 3 illustrates the funnel cock device 100 customized to fit another common bottle 6 with a wider mouth. The diameter of the large inlet opening 19 of the funnel cock device 100 (typically 7 to 10 centimeters) is oversized and ballooned 23 to snugly cradle the inverted wider mouth bottle about the lip 10 while cross-hatched grooves or ridges 22 (generally 0.5 to 2 centimeters in length and 0.1 to 1 millimeters in depth or height) prevent the surfaces from forming a seal. Since the neck 17 of this bottle type is short, it is also critical with this configuration that the large inlet opening 19 or ballooned part 23 of the funnel cock device 100 extend entirely up to the body 21 of the bottle to create a gap 7 of sufficient volume to contain overflow. This gap 7 extends from 1 to 6 centimeters below the large inlet opening 19 to accommodate most bottle sizes and shapes used for the device 100 application.

Furthermore, instead of a stopcock 2, the small outlet opening 20 can terminate with a section of thin wall tubing that may be manually or mechanically clasped to control liquid flow passing through it. Further, in addition to, or in place of the stopcock 2, the small outlet opening 20 can terminate with a filter, or receptacle to attach to a filter, fabricated of an inert, hydrophobic membrane allowing organic solvents to pass while obstructing the passage of water.

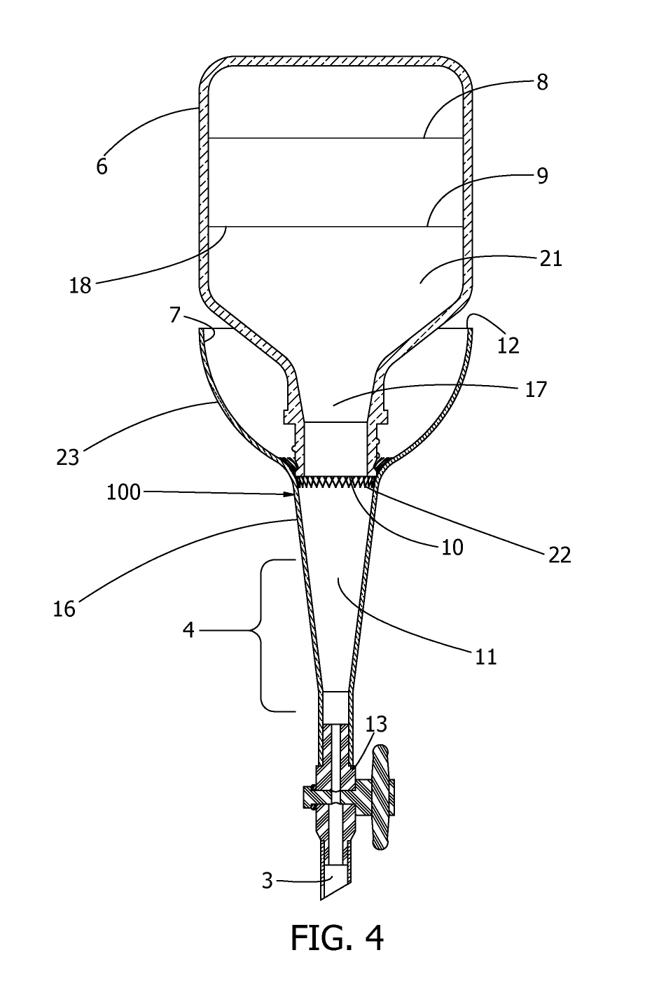

FIG. 4 illustrates the funnel cock device 100 with the ballooned 23 opening in use with a narrow mouth inverted bottle 6 comprising two phases of liquid, a top layer 8 and a bottom layer 9. The ballooned 23 opening fits snugly to the narrow mouth bottle 6, allowing the lip 10 to contact the cross-hatched grooves or ridges 22 preventing the surfaces from forming a seal.

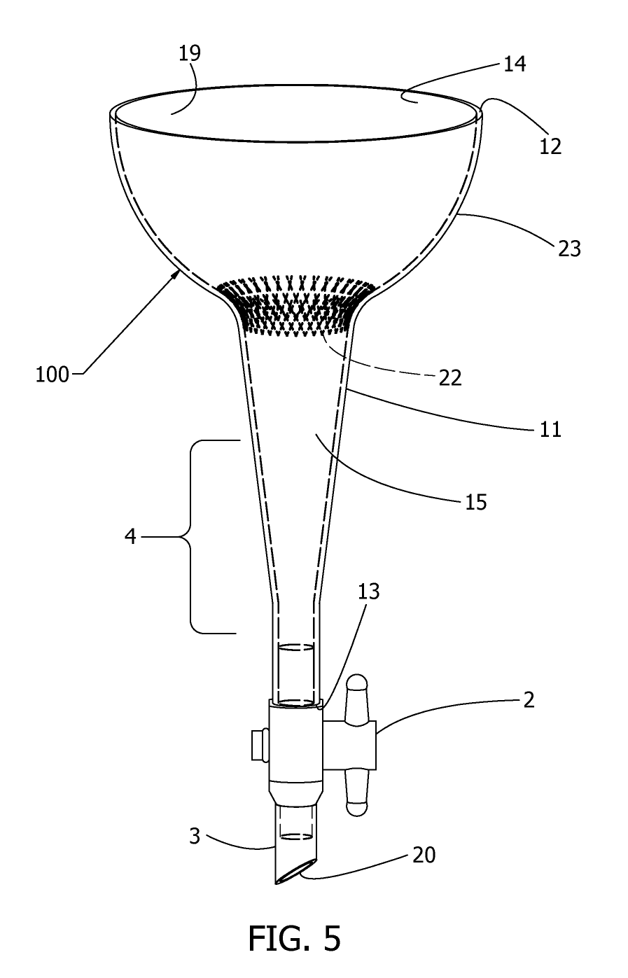

FIG. 5 illustrates the funnel cock device 100 with the ballooned 23 opening and cross-hatched grooves or ridges 22. The ballooned 23 opening maximizes the overflow cavity and the diameter of the large inlet opening 19 of the funnel cock device 100 is typically 7 to 10 centimeters. There is a delicate balance at the interface between the bottle lip 10 and the funnel cock device 100 allowing air to enter while restricting the flow sufficiently to prevent overflow. If you overturn a bottle 6 containing liquid onto the funnel cock device 100 it will overflow if the air gap is too large or the overflow volume is too small. Typically, the large or ballooned 23 opening of the funnel cock device 100 is ballooned (or oversized) and extends up to the body of the bottle 6 yet does not exceed the width of the bottle 6.

Additionally, the funnel cock device 100 comprises cross-hatched grooves or ridges 22 to also prevent overflow. However, to work properly, the cross-hatched grooves or ridges 22 must be very shallow and thin. If there is too much of a gap the heavy liquid will too quickly fill the overflow volume when the bottle 6 is overturned. With the limited overflow volume of the funnel cock device 100, just scratching the inner surface of the funnel cock device 100 works to produce the desired result. For example, the cross-hatched grooves or ridges 22 must be between 0.1 to 1 millimeters in depth or height to perform the required function. Typically, the cross-hatched grooves or ridges 22 are positioned on the interior surface 14 of the funnel cock wall 16, and are limited to the area where the inverted bottle 6 contacts the funnel cock device 100 (i.e., the point at which the diameters of the funnel cock device 100 and the lip 10 of the mated bottle 6 are identical—this typically extends 1 to 6 centimeters from the top end 12 of the funnel cock to the grooved or ridged cross-hatched area 22).

Additionally, a method for separating at least two immiscible liquids is disclosed. The steps comprise inverting a bottle 6 containing immiscible liquids onto a funnel cock device 1 (or other embodiment of the funnel cock device 100) equipped with a flow regulating device, such as a stopcock 2 or similar device. Then, allowing the heavier immiscible liquid to pass through the funnel cock device 1 as the interface 18 between the fluids is viewed though a clear or translucent wall of the funnel cock device 1. Then, preventing a seal from forming via utilizing grooves or ridges within the interior surface 14 of the funnel cock wall 16, which allow air to enter the bottle 6 when fluids within the bottle 6 inverted onto the funnel cock device 1 are discharged. Finally, containing overflow that naturally occurs with the act of overturning a bottle 6 full of liquids onto an open funnel cock device 1.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A funnel cock device to facilitate the separation of an immiscible liquid contained in an inverted bottle, comprising:
a conical-shaped body comprising a longitudinal axis, a top end, a bottom end, a large inlet opening, and a small outlet opening for allowing liquid to pass through the conical-shaped body;
a stopcock secured to the bottom end of the conical-shaped body; and
a spout secured to the stopcock; and
wherein the bottle is inverted and inserted onto the large inlet opening of the conical-shaped body to form an inner open space between a lip of the bottle, a neck of the bottle, and an interior surface of a funnel cock wall that is utilized to retain liquid overflow.

2. The funnel cock device of claim 1, wherein an inner diameter of the large inlet opening exactly matches an outer diameter of the lip of the bottle at a point not less than 1 centimeter or more than 6 centimeters below a crest of the large inlet opening.

3. The funnel cock device of claim 1, further comprising a plurality of substantially vertical grooves on the interior surface of the funnel cock wall, wherein the plurality of substantially vertical grooves are between 0.1 to 1 millimeters in height.

4. The funnel cock device of claim 3, wherein the plurality of substantially vertical grooves traverse a point at which a diameter of the conical-shaped body and a diameter of the lip of the bottle are identical and prevent a seal from forming while allowing air to enter the bottle when fluids within the bottle inverted onto the conical-shaped body are discharged.

5. The funnel cock device of claim 1, further comprising a cross-hatched configuration of grooves or ridges on the interior surface of the funnel cock wall, wherein the cross-hatched configuration of grooves or ridges are between 0.1 to 1 millimeters in height.

6. The funnel cock device of claim 5, wherein the cross-hatched configuration of grooves or ridges traverse a point 1 to 6 centimeters below a crest of the large inlet opening at which a diameter of the conical-shaped body and a diameter of the lip of the bottle are identical and prevent a seal from forming while allowing air to enter the bottle when fluids within the bottle inverted onto the conical-shaped body are discharged.

7. The funnel cock device of claim 1, wherein the conical-shaped body further comprises a section of clear or translucent material between the small outlet opening and the large inlet opening whereby an interface between two immiscible liquids may be visualized as the fluids flow through the conical-shaped body.

8. The funnel cock device of claim 1, wherein the conical-shaped body is constructed of fluorinated ethylene propylene, polyethylene, polypropylene or glass.

9. The funnel cock device of claim 8, wherein the conical-shaped body is inert to prevent damage from chemically aggressive solvents commonly used to extract organic chemicals from water.

10. The funnel cock device of claim 9, wherein the valve and stopcock are manufactured of inert material.

11. The funnel cock device of claim 10, wherein the valve and stopcock are manufactured of polypropylene.

12. The funnel cock device of claim 3, wherein the plurality of substantially vertical grooves are identical in size.

13. The funnel cock device of claim 1, wherein the large outlet opening is expanded in size, such that the large outlet opening is 7 to 10 centimeters in diameter.

14. A funnel cock device to facilitate the separation of an immiscible liquid contained in an inverted bottle, comprising:
a conical-shaped body comprising a longitudinal axis, a top end, a bottom end, a large inlet opening, and a small outlet opening for allowing liquid to pass through the conical-shaped body;
a liquid control component secured to the bottom end of the conical-shaped body; and
wherein the bottle is inverted and inserted onto the large inlet opening of the conical-shaped body to form an inner open space between a lip of the bottle, a neck of the bottle, and an interior surface of a funnel cock wall that is utilized to retain liquid overflow; and
a cross-hatched configuration of grooves on the interior surface of the funnel cock wall for preventing a seal from forming while allowing air to enter the bottle when fluids within the bottle inverted onto the conical-shaped body are discharged, wherein the cross-hatched configuration of grooves is between 0.1 to 1 millimeters in height.

15. The funnel cock device of claim 14, wherein the cross-hatched configuration of grooves is between 0.5 to 2 centimeters in length.

16. The funnel cock device of claim 14, wherein the liquid control component is a section of thin wall tubing that may be manually or mechanically clasped to control liquid flow passing through it.

17. The funnel cock device of claim 14, wherein the liquid control component is a filter, or receptacle to attach to a filter, fabricated of an inert, hydrophobic membrane allowing organic solvents to pass while obstructing passage of water.

18. The funnel cock device of claim 14, wherein the cross-hatched configuration of grooves traverse a point at which a diameter of the conical-shaped body and a diameter of the lip of the bottle are identical.

19. The funnel cock device of claim 14, wherein the large outlet opening is expanded in size, such that the large outlet opening is 7 to 10 centimeters in diameter.

20. A method for separating at least two immiscible liquids, comprising the steps of:
(a) inverting a bottle containing immiscible liquids onto a funnel equipped with a flow regulating device;
(b) allowing the heavier immiscible liquid to pass through the funnel as the interface between the fluids is viewed though a clear or translucent wall of the funnel;
(c) preventing a seal from forming while allowing air to enter the bottle when fluids within the bottle inverted onto the funnel are discharged; and
(d) containing overflow that naturally occurs with the act of overturning a bottle full of liquids onto an open funnel.
